(19) United States
(12) Patent Application Publication
(10) Pub. No.: US 2018/0130349 A1
(43) Pub. Date: May 10, 2018

(54) METHODS AND SYSTEMS FOR DISPLAYING VIRTUAL SIGNS BASED ON VEHICLE TO EVERYTHING COMMUNICATIONS

(71) Applicant: GM GLOBAL TECHNOLOGY OPERATIONS LLC, Detroit, MI (US)

(72) Inventors: JIANG DU, BEAVERTON, OR (US); YING HUANG, SHANGHAI (CN)

(73) Assignee: GM GLOBAL TECHNOLOGY OPERATIONS LLC, Detroit, MI (US)

(21) Appl. No.: 15/346,827

(22) Filed: Nov. 9, 2016

(51) Int. Cl. G08G 1/0967; B60K 35/00

(52) U.S. Cl. CPC G08G 1/096783; B60K 35/00; B60K 2350/357; B60K 2350/1076; B60K 2350/1056

(57) ABSTRACT

Methods and systems are provided for notifying a user. In one embodiment, a method includes: receiving information from a vehicle at a road side unit; receiving information from sensors at the road side unit; processing, by a processor of the road side unit, the information from the vehicle and the information from the sensors to determine a virtual sign display strategy; and communicating a virtual sign type to a control module to display a virtual sign to a user based on the virtual sign display strategy.

### TECHNICAL FIELD

The technical field generally relates to virtual signs, and more particularly to methods and systems for managing the display of virtual signs.

### BACKGROUND

Vehicle-to-everything (V2X) communication is the passing of information from a vehicle to any entity that may affect the vehicle, and vice versa. It is a vehicular communication system that incorporates other more specific types of communication including, but not limited to, Vehicle-to-Infrastructure (V2I), Vehicle-to-vehicle (V2V), Vehicle-to-Pedestrian (V2P), Vehicle-to-device (V2D), and Vehicle-to-grid (V2G).

Roadside units distributed at various locations along a road can collect information about vehicles and/or the environment based on the V2X communications. It is desirable to provide methods and systems to process the received information for the purpose of managing the display of virtual signs to notify users of various conditions. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for notifying a user. In one embodiment, a method includes: receiving information from a vehicle at a road side unit; receiving information from sensors at the road side unit; processing, by a processor of the road side unit, the information from the vehicle and the information from the sensors to determine a virtual sign display strategy; and communicating a virtual sign type to a control module to display a virtual sign to a user based on the virtual sign display strategy.

In one embodiment, a system includes a road side unit including a non-transitory computer readable medium. The non-transitory computer readable medium includes: a first module that receives information from a vehicle, and that receives information from sensors. The non-transitory computer readable medium further includes a second module that processes the information from the vehicle and the information from the sensors to determine a virtual sign display strategy. The non-transitory computer readable medium further includes a third module that communicates a virtual sign type to a control module to display a virtual sign to a user based on the virtual sign display strategy.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a virtual sign management system that is associated with a plurality of vehicles in accordance with various embodiments;

FIGS. 2A and 2B are illustrations of virtual signs that can be displayed at various times and locations in accordance with various embodiments;

FIG. 3 is a dataflow diagram illustrating roadside unit of the virtual sign management system in accordance with various embodiments;

FIGS. 4 and 5 are flowcharts illustrating virtual sign management methods in accordance with various embodiments;

FIG. 6 is an illustration of a four-way intersection for use with various embodiments; and

FIG. 7 is an illustration of a map for use in processing a strategy in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of control systems, and that the system described herein is merely one example embodiment.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

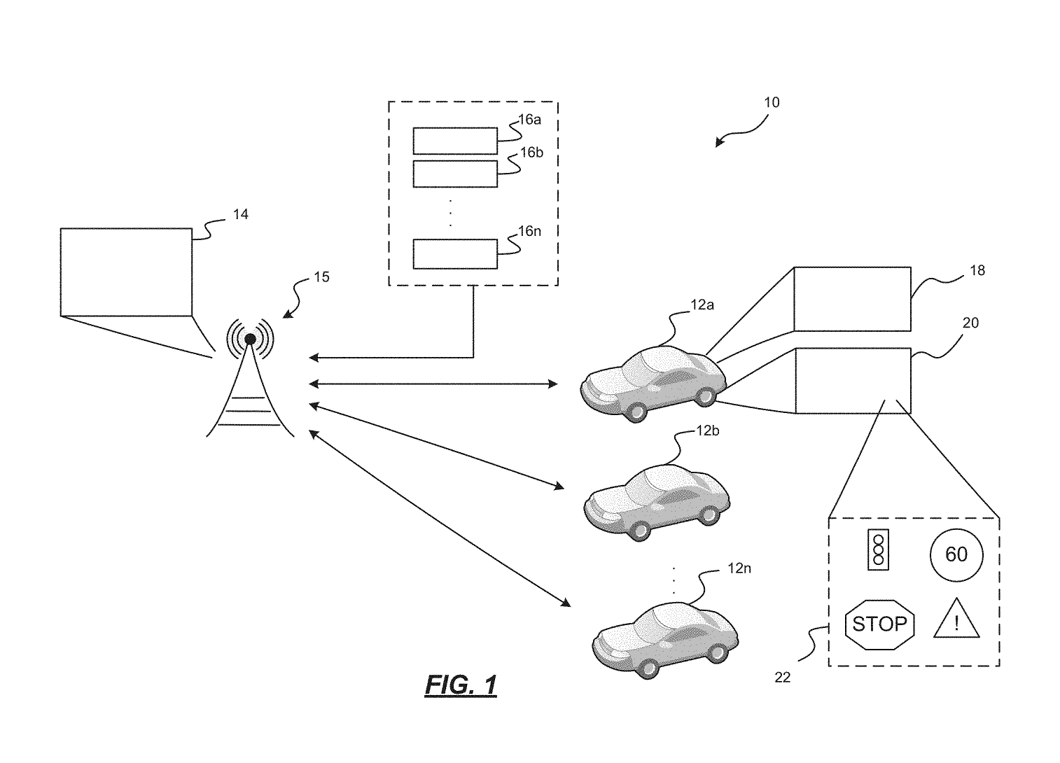

With reference now to FIG. 1, an exemplary virtual sign management system 10 is shown to be associated with one or more vehicles 12a-12n. As can be appreciated, the vehicles 12a-12n may be any vehicle type such as, but not limited to a road vehicle, an off-road vehicle, an aircraft, a watercraft, a train, a motorcycle, electrical moving machine, etc. As can further be appreciated, the virtual sign management system 10 may be associated with non-vehicles having a control module and display device such as, but not limited to, personal devices or build in devices of bicyclists or pedestrians or other road participant. For exemplary purposes only, the remainder of the disclosure will be discussed in the context of the virtual sign management system 10 being associated with vehicles 12. Although the figures shown herein depict an example with certain arrangements of elements, additional intervening elements, devices, features, or components may be present in actual embodiments. It should also be understood that FIG. 1 is merely illustrative and may not be drawn to scale.

As shown, the virtual sign management system 10 includes at least one road side unit 14, one or more sensors 16a-16n, and the one or more vehicles 12a-12n. The sensors 16a-16n sense observable conditions of the environment of the vehicles 12a-12n and/or the roadside unit 14, and generate sensor signals based thereon. In various embodiments, the sensors sense road conditions, traffic conditions, weather conditions, or other conditions of an environment of the vehicles 12a-12n and/or the road side unit 14. The sensor signals are communicated to the road side unit 14 for further processing.

The vehicles 12a-12n each include a control module 18 that is configured to communicate information to and/or receive information from the road side unit 14. The communication may be by way of Dedicated Short Range Communications (DSRC), LTE-V2X, or other communication system 15 (such as a cellular communication system). In various embodiments, the control module 18 is configured to communicate information about the vehicle 12a-12n and/or about the current environment of the vehicle 12a-12n to the road side unit 14. Such information can include, but is not limited to, vehicle speed, heading, position, brake status, steering wheel angle, acceleration, yaw rate, vehicle parameters, etc. In various embodiments, the control module 18 is configured to receive information about a virtual sign from the road side unit 14. For example, the information may include an image of a particular sign, a type of a sign, a rule associated with the sign, etc.

In response to the received information from the road side unit 14, the control module 18 is further configured to cause one or more virtual signs 22 to be displayed or provided to a user of the vehicle 12a-12n. For example, the control module 18 is configured to generate display signals. The display signals are received by at least one interface device 20. The interface device 20 then displays or provides an indication of the one or more virtual signs 22 based on the received display signals. The virtual signs 22 can include any image representing a traffic sign or warning sign or an indication of the content of the image and is not limited to the illustrated examples.

As can be appreciated, the interface device 20 can be any display device or interface of the vehicle 12a-12n including, but not limited, part of an infotainment system or other visual, audio, haptic interface within a cabin of the vehicle 12a-12n. The interface device 20 can notify a human driver or a machine that controls vehicle behavior. As can be appreciated, in various embodiments, the control module 18 can be implemented as a single control module or multiple control modules that communicate over a communication medium such as a bus or other medium.

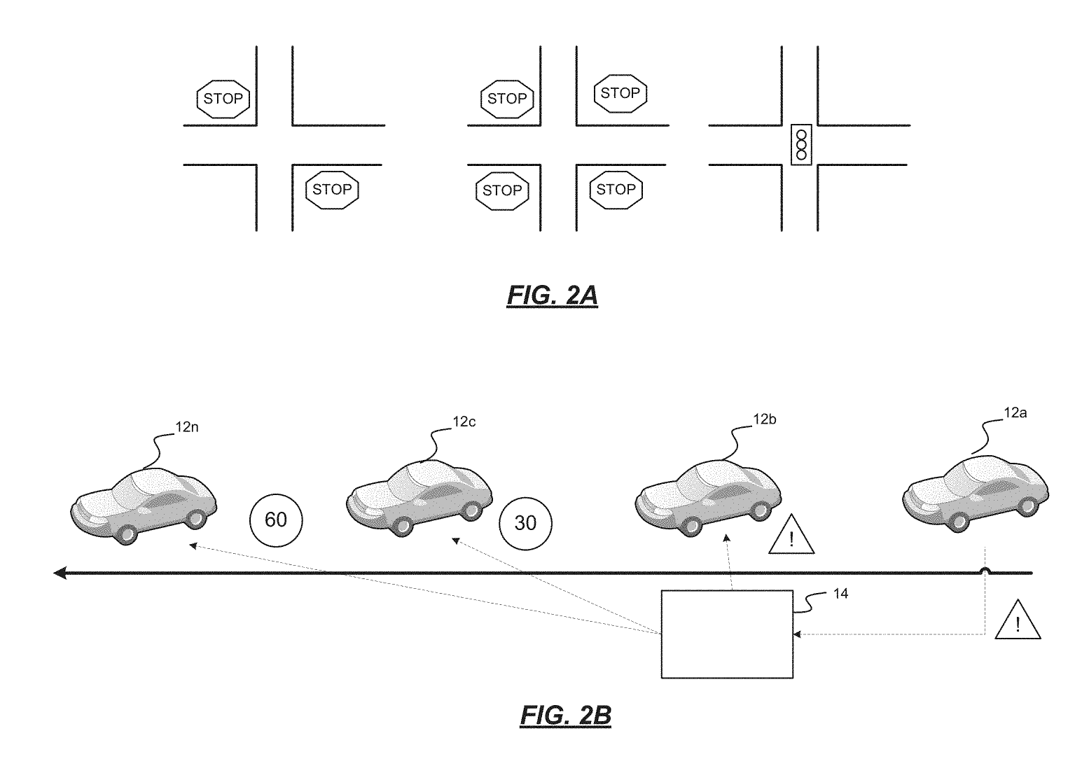

The roadside unit 14 includes at least one module that receives the sensor signals and/or the communications from the control modules 18 of the vehicles 12a-12n. As used herein, roadside unit refers to any station type that can collect information and communicate information and can include, but is not limited to, equipment mounted along a road, a central tower, a cloud server, etc. The roadside unit 14 can be one unit, or can be multiple units functioning together. The module of the roadside unit processes the received signals and/or the communications and dynamically determines the virtual signs 22 to be provided by the vehicles 12a-12n at various locations. The virtual signs 22 are dynamic based on the received data. For example, the virtual sign type communicated to a first vehicle at a first time and a first location may be different than a virtual sign type communicated to the first vehicle at a second time and at the same location. As shown in FIG. 2A, a virtual sign type communicated at an intersection may be two-way stop, a four-way stop, or a traffic light.

In another example, the virtual sign type communicated to the first vehicle 12a at a first location may be different than a virtual sign type communicated to a second vehicle at a second location at a same or different time. As shown in the example of FIG. 2A, a virtual sign 22 may be received from a first vehicle 12a, and based thereon, virtual signs of different types are communicated to other vehicles 12b-12n at different locations.

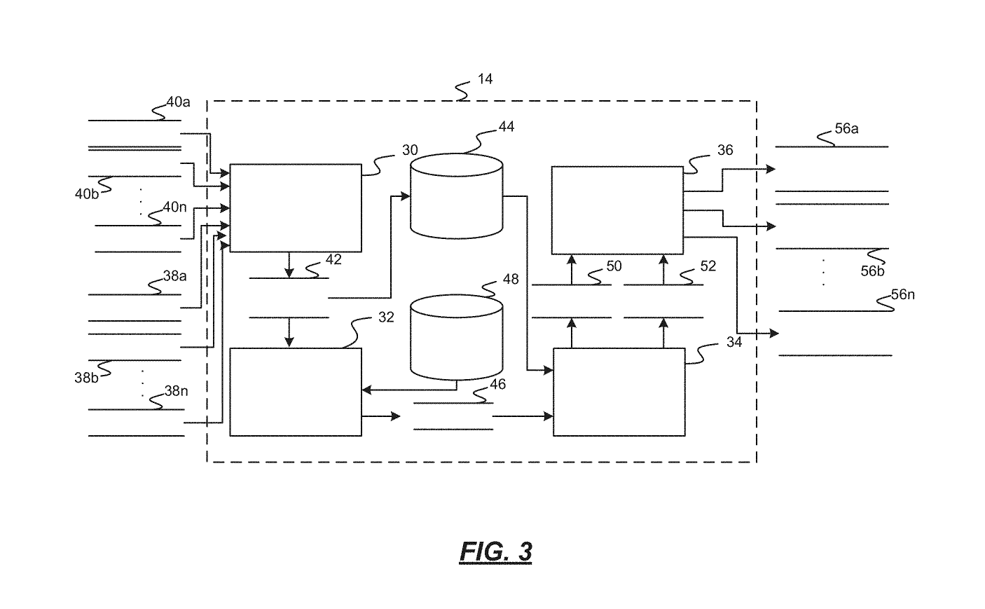

Referring now to FIG. 3 and with continued reference to FIG. 1, dataflow diagrams illustrate modules of the roadside unit 14 in more detail in accordance with various exemplary embodiments. As can be appreciated, various exemplary embodiments of the roadside unit 14, according to the present disclosure, may include any number of modules and/or sub-modules. In various exemplary embodiments, the modules and sub-modules shown in FIG. 2 may be combined and/or further partitioned to similarly manage the display of virtual signs 22 to users. In various embodiments, the roadside unit 14 receives inputs from the one or more of the sensors 16a-16n and the vehicles 12a-12n, and/or from other modules (not shown) within the roadside unit 14. In various embodiments, the roadside unit 14 includes an information collection module 30, a strategy determination module 32, a sign determination module 34, and a sign communication module 36.

The information collection module 30 receives as input vehicle data 38a-38n communicated from vehicles 12a-12n within a range of the roadside unit 14. In addition, or alternatively, the information collection module 30 receives as input sensor data 40a-40n obtained from the sensor signals that were generated by the sensors 16a-16n. The information collection module 30 assembles the data based on a time (e.g., a time of occurrence, a time of receipt, etc.), a type of the data, and/or values of the data. For example, the data 38a-38n, 40a-40n is assembled such that it defines a scenario (e.g., a traffic scenario, a road condition scenario, etc.) In various embodiments, the assembled data 42 is stored in a datastore 44.

The strategy determination module 32 receives as input the assembled data 42. The strategy determination module 32 evaluates the assembled data 42 and determines a scenario that best fits with the assembled data 42. The scenario may be any driving, traffic, or weather scenario that would benefit from a notification. For example, the scenario may be, but is not limited to, a four-way intersection scenario, a three-way intersection scenario, a crosswalk scenario, a weather condition scenario, an accident to malfunction vehicle, a control loss vehicle (including but not limited to the activation of ABS, ESP, TSC etc.), a road construction situation etc.

Based on the determined scenario, the strategy determination module 32 selects a sign determination strategy 46. For example, a datastore 48 may store a plurality of sign determination strategies 46 and an association of each strategy with one or more scenarios. In this example, the strategy determination module 32 selects a particular strategy 46 from the stored strategies based on the determined scenario and the association.

The sign determination module 34 receives as input the strategy 46 and the assembled data 42. The sign determination module 34 evaluates the assembled data 42 based on the strategy 46 to dynamically determine which virtual sign 22 to be displayed for each vehicle 12a-12n. The sign determination strategy 46, when implemented, computes one or more statistics based on the assembled data 42, and based thereon selects particular virtual sign types 50 to be displayed and selects which location and/or which vehicles 54 are to display the particular virtual sign type 50. For example, a four-way intersection strategy computes traffic flow for each of the four ways and based thereon selects a stop sign type or traffic light type and selects one or more ways of the intersection where vehicles traveling upon should display the selected type. As can be appreciated, the four-way intersection strategy is one example and other strategies may be implemented in various embodiments.

The sign communication module 36 receives as input the virtual sign type 50 and the vehicle and/or location 52 to display the sign. The sign communication module 36 communicates the virtual sign type 50 to the appropriate vehicle or vehicles 12a-12n at the particular location 54. For example, communications 56a-56n may be a direct communication to a particular vehicle 12a-12n and/or may be a broadcast communication to many vehicles 12a-12n at or near the location 54.

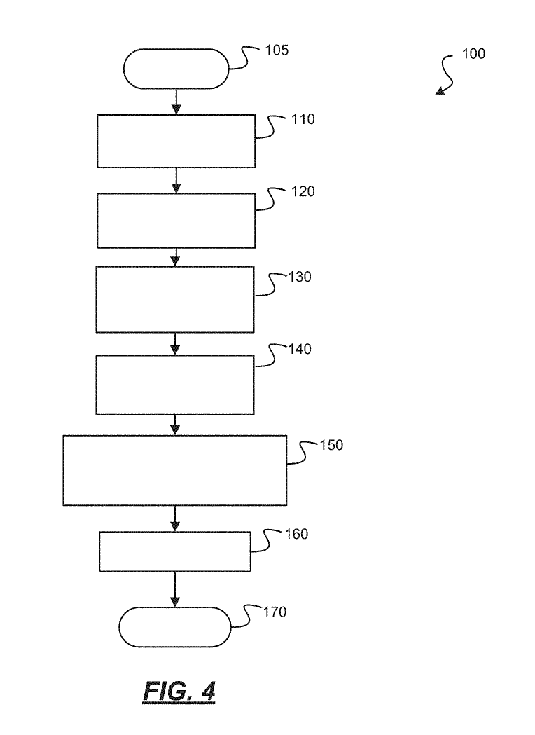

With reference now to FIG. 4, and with continued reference to FIGS. 1 through 3, a flowchart illustrates a method 100 for dynamically managing the display of virtual signs 22. The method 100 can be implemented in connection with the roadside unit 14 of FIG. 1 and can be performed by the modules 30-36 of FIG. 3 in accordance with various exemplary embodiments. As can be appreciated in light of the disclosure, the order of operation within the method 100 is not limited to the sequential execution as illustrated in FIG. 4, but may be performed in one or more varying orders as applicable and in accordance with the present disclosure. As can further be appreciated, the method 100 of FIG. 4 may be enabled to run continuously, may be scheduled to run at predetermined time intervals during operation of the roadside unit, and/or may be scheduled to run based on predetermined events.

In various embodiments, the method 100 may begin at 105. Vehicle data 38a-38n is received from vehicles 12a-12n within a predefined range of the roadside unit 14 via vehicle to structure communications as described above at 110. Substantially simultaneously, before, and/or after the step of 110, sensor data 40a-40n is collected from the sensors 16a-16n at 120. The vehicle data 38a-38n and the sensor data 40a-40n is assembled at 130 (assembled data 42) and processed at 140. For example, at 140, the assembled data 42 is evaluated to select the strategy 46. Thereafter, the strategy 46 is processed based on the assembled data 42 to determine the virtual sign type 50, and the location, and/or the vehicle 52 to display the sign type at 150. The virtual sign type 50 is then communicated based on the location and/or the vehicle 52 at 160. Thereafter, the method may end at 170.

With reference now to FIG. 5, and with continued reference to FIGS. 1 through 3, a flowchart illustrates a method 200 associated with an intersection strategy, for example a four-way intersection strategy. The method 200 can be implemented in connection with the roadside unit 14 of FIG. 1 and can be performed by the modules 30-36 of FIG. 3 in accordance with various exemplary embodiments. As can be appreciated in light of the disclosure, the order of operation within the method 200 is not limited to the sequential execution as illustrated in FIG. 5, but may be performed in one or more varying orders as applicable and in accordance with the present disclosure. As can further be appreciated, the method 200 of FIG. 5 may be enabled to run continuously, may be scheduled to run at predetermined time intervals during operation of the roadside unit 14, and/or may be scheduled to run based on predetermined events.

In various embodiments, the method may begin at 205. The assembled data 42 is evaluated at 210 to determine if it is associated with an intersection scenario. If the assembled data 42 is associated with an intersection scenario at 210, it is determined whether the assembled data 42 is associated with a four-way intersection scenario at 220. If the associated data is associated with a four way intersection at 220, the strategy 46 for a four-way intersection is selected at 230 and performed at 240.

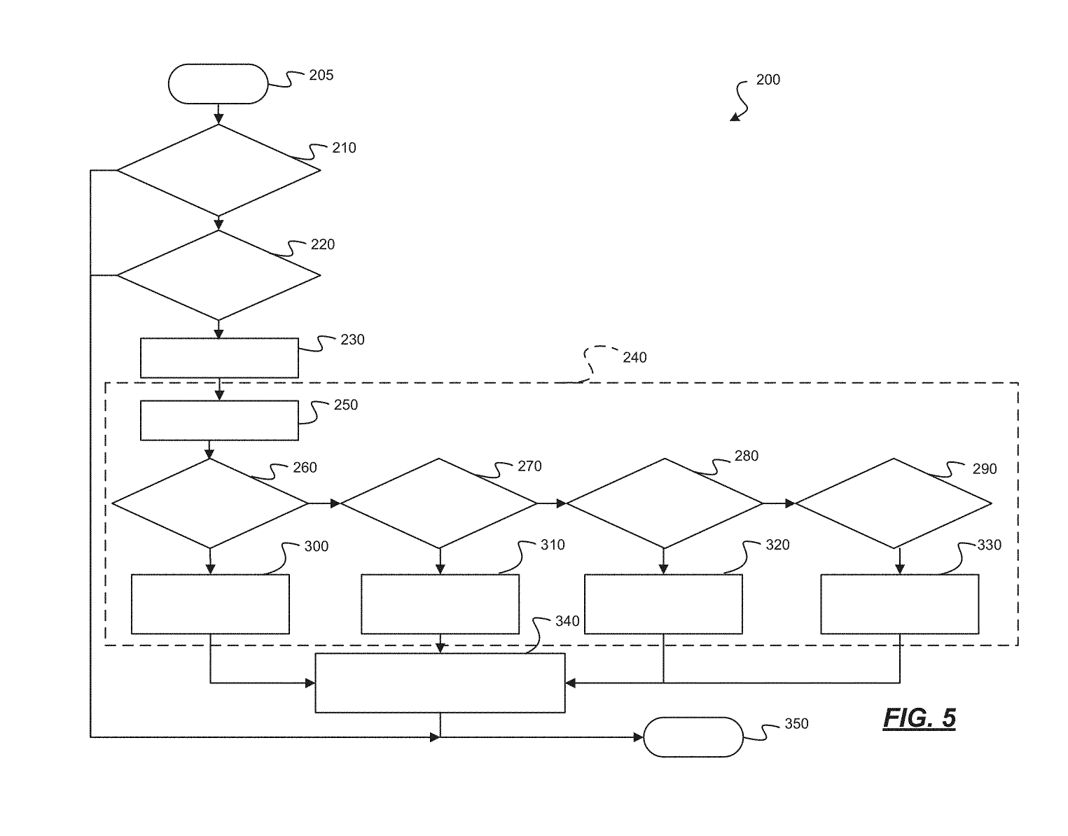

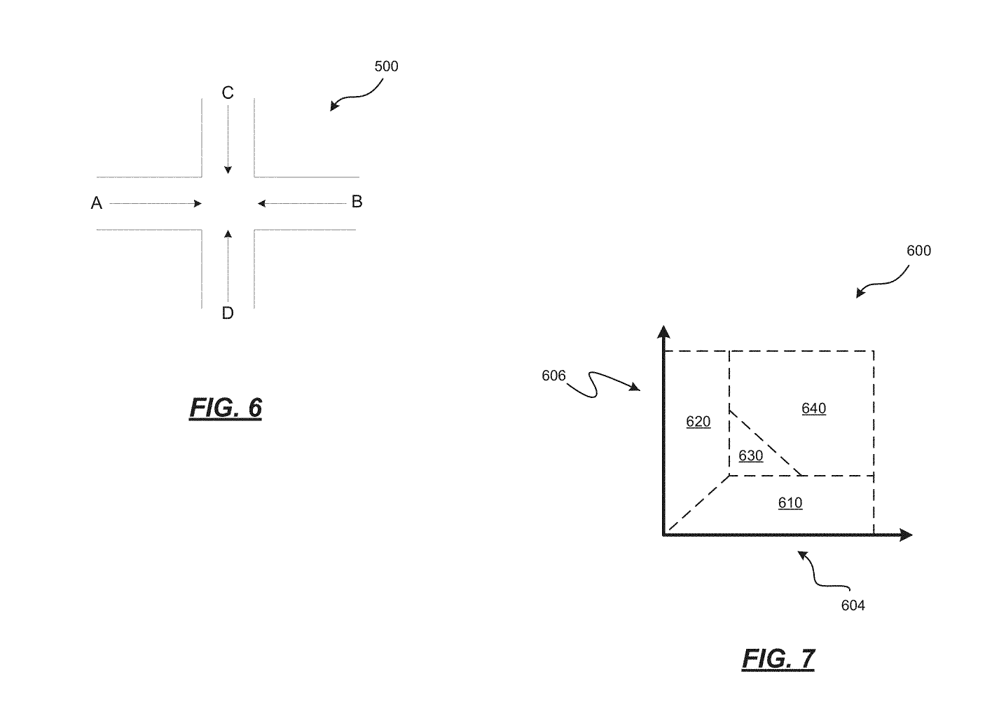

For example, a traffic flow is computed for each of the four ways (A, B, C, D as labeled in the four-way intersection 500 of FIG. 6) at 250. The traffic flows are then evaluated at 260-290 based on a defined flow map (600 shown in FIG. 6) defined by the traffic flow of C and D on a first axis 604 and the traffic flow of A and B on a second axis 606. For example, at 260, if the traffic flow from C, D (FIG. 6) is much higher than the traffic flow of A, B (FIG. 6) at 260 (as shown by the range 610 of the map 600 FIG. 7), then virtual sign pattern one associated with a two-way stop sign on A, B (FIG. 6) is selected at 300. Otherwise, if the traffic flow from A, B (FIG. 6) is much higher than that of C, D (FIG. 6) at 270 (as shown by the range 620 of the map 600 FIG. 7), then virtual sign pattern two 610 associated with two-way stop sign on C, D (FIG. 6) is selected at 310. Otherwise, if the traffic flow of both A, B (FIG. 6) and C, D (FIG. 6) are median at 280 (as shown by the range 630 of the map 600 FIG. 7), then virtual sign pattern three associated with 4-way stop sign on A, B, C, D is selected at 320. Otherwise, if the traffic flows of both A, B (FIG. 6) and C, D (FIG. 6) are high at 290 (as shown by the range 640 of the map 600 FIG. 7), then virtual sign pattern four associated with a traffic light is selected at 330.

Thereafter, the virtual sign types corresponding to the selected pattern are broadcast to the surrounding vehicles at the appropriate locations at 340; and the method may end at 350.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of notifying a user, comprising:
receiving information from a vehicle at a road side unit;
receiving information from sensors at the road side unit;
processing, by a processor of the road side unit, the information from the vehicle and the information from the sensors to determine a virtual sign display strategy for displaying a virtual sign indicating a traffic control device to a user based on a current traffic scenario, wherein the display of the virtual traffic sign is dynamic according to the determined virtual sign display strategy; and
communicating a virtual sign type to a control module to display a virtual sign to a user based on the virtual sign display strategy.

2. The method of claim 1, wherein the virtual sign display strategy, when performed, determines the virtual sign type.

3. The method of claim 2, wherein the virtual sign display strategy, when performed, determines a virtual road map and a location with respect to the virtual road map to display the virtual sign according to the virtual sign type.

4. The method of claim 1, wherein the virtual sign display strategy, when performed, determines a vehicle to display the virtual sign according to the virtual sign type.

5. The method of claim 1, wherein the communicating is by way of a broadcast.

6. The method of claim 1, wherein the communicating is by way of a direct communication.

7. The method of claim 1, wherein the communicating the virtual sign type is to the vehicle.

8. The method of claim 1, wherein the communicating the virtual sign type is to at least one other vehicle.

9. The method of claim 1, wherein the communicating the virtual sign type is to an other road participant.

10. The method of claim 1, wherein the processing comprises:
assembling information from the vehicle and the information from the sensors into assembled data;
determining the current traffic scenario based on the assembled data; and
determining the virtual sign display strategy based on the current traffic scenario.

11. A system for notifying a user, comprising:
a road side unit comprising a non-transitory computer readable medium,
the non-transitory computer readable medium comprising:
a first module that receives information from a vehicle, and that receives information from sensors;
a second module that processes the information from the vehicle and the information from the sensors to determine a virtual sign display strategy for displaying a virtual sign indicating a traffic control device to a user based on a current traffic scenario, wherein the display of the virtual traffic sign is dynamic according to the determined virtual sign display strategy; and
a third module that communicates a virtual sign type to a control module to display the virtual sign to a user based on the virtual sign display strategy.

12. The system of claim 11, wherein the virtual sign display strategy, when performed, determines the virtual sign type.

13. The system of claim 12, wherein the virtual sign display strategy, when performed, determines a virtual road map and a location with respect to the virtual road map to display the virtual traffic sign according to the virtual sign type.

14. The system of claim 11, wherein the virtual sign display strategy, when performed, determines a vehicle to display the virtual sign according to the virtual sign type.

15. The system of claim 11, wherein the third module communicates by way of a broadcast.

16. The system of claim 11, wherein the third module communicates by way of a direct communication.

17. The system of claim 11, wherein the third module communicates the virtual sign type to the vehicle.

18. The system of claim 11, wherein the third module communicates the virtual sign type to at least one other vehicle.

19. The system of claim 11, wherein the third module communicates the virtual sign type to another road participant.

20. The system of claim 11, wherein the processing by the second module comprises:
assembling information from the vehicle and the information from the sensors into assembled data;
determining the current traffic scenario based on the assembled data; and
determining the virtual sign display strategy based on the current traffic scenario.
